(19) United States
(12) Patent Application Publication
(10) Pub. No.: US 2004/0130314 A1
(43) Pub. Date: Jul. 8, 2004

(54) Sensor adjusting magnetic field

(75) Inventors: Jon W. Bossoli, Cheshire, CT (US); Alan S. Morrison, Southington, CT (US)

Correspondence Address: Elsa Keller, Siemens Corporation, Intellectual Property Department, 170 Wood Avenue South, Iselin, NJ, 08830, US

(73) Assignee: Siemens VDO Automotive Corporation

(21) Appl. No.: 10/663,564

(22) Filed: Sep. 16, 2003

Related U.S. Application Data
(60) Provisional application No. 60/438,737, filed on Jan. 8, 2003.

(51) Int. Cl. G01P 3/48; G01B 7/30

(52) U.S. Cl. 324/174; 324/207.2; 324/207.21; 324/207.22

(57) ABSTRACT

A magnetic assembly apparatus and method for optimizing the magnetic field characteristics generated by the magnetic assembly used in active speed sensors. The magnetic assembly comprising a plurality of pole pieces inserted within a tubular magnet. By optimizing the geometry of the magnetic assembly, the region of usable magnetic field is altered to accommodate the switching characteristics of a given magnetic sensing device allowing the use of low cost sensing devices.

### FIELD OF INVENTION

The present invention relates to a magnetic assembly for use in active speed sensors and more particularly, to methods and apparatus for optimizing the magnetic field characteristics generated by the magnetic assembly in an active speed sensor.

### BACKGROUND

Tubular rare earth biasing magnets provide small and reasonably low cost magnetic field shapes for use with active sensing technologies, including Hall Effect and Magneto-Resistor type sensors. Hall Effect and Magneto-Resistor sensors are generally realized as magnetic switches or latches that are based on small integrated circuits. The low-cost variety of these devices normally possess a fixed or one-time programmable (OTP) switching threshold. These devices operate on the principle that once the Hall Effect device or Magneto-Resistor is subjected to a magnetic field whose intensity is sufficient to exceed the device's switching threshold, the device will switch output states. The output configuration of these devices can be either an open collector transistor or a type of dc current modulation depending on the application. Switch states are a digital signaling of the device output consisting of two discrete signaling levels, indicating the sensed magnetic field intensity relative to the device switching threshold, inclusive of any hysteresis applied to the threshold.

The basic goal of designing a sensor around either a Hall Effect or Magneto-Resistor sensing device is to exploit the shape and intensity of the magnetic field in a way that target induced variation in the magnetic field causes excursions through the switchpoint which are designed into the device by the manufacturers. However most devices as manufactured, possess a fixed switchpoint, or alternatively have a limited range of switchpoints that are programmable by the user. Considering this design limitation, it is not unusual for the prevailing signal excursions to exist at the limits of, or outside of a preferred device's switchpoint or range of switchpoints. Therefore, it may be necessary to manipulate the shape and intensity of magnetic field to attain the desired field condition. Previous inventions accomplished this manipulation by altering the geometry of the tubular biasing magnet to create useable field conditions. However, geometric alteration of the magnet may only produce small influences in the shape and intensity of the magnetic field. These influences are restricted by mechanical limits of construction of both magnet and sensing device.

The most significant disadvantage resulting from the mechanical limits of construction of the magnet and sensing device is an unoptimized magnetic circuit. These mechanical limitations include geometric limitations in the construction of the magnet to impart minimal mechanical properties which permit reasonable fabrication yields and safe handling. Additionally, the Hall Effect or Magneto-Resistor sensing element must be encapsulated by some packaging material, typically a thermoset resin, for handling and environmental protection resulting in a minimum possible distance between the Hall Effect or Magneto-Resistor sensing element and the magnet face. These mechanical constraints combine to produce a higher quiescent magnetic field strength at the sense element than desired. Also, the field gradient and shape of the magnetic field is uncontrolled with regard to, and to the extent of manufacturing tolerances such as, material density and dimensional tolerances of the magnet. In the prior art, methods to apply expensive self-adjusting sensing devices to overcome this unoptimized magnetic condition were used.

Accordingly, it is an object of the present invention to overcome and mitigate at least one of the foregoing disadvantages.

### SUMMARY OF INVENTION

It is therefore an object of the present invention to save costs by using an apparatus and method that allows configuration and compatibility with a wide range of available devices.

It is another object of the present invention to provide an improved magnetic assembly for use with active speed sensors.

It is an object of this invention to control the size, shape, and location of a “sweet spot” or optimized magnetic field region by varying the diameter and length of a permeable magnetic core and the thickness of a permeable magnetic pole plate.

It is another object of the present invention to use the diameter, length and thickness of a plurality of pole pieces to optimize the magnetic field condition for a sensing element.

It is a further object of the present invention to control magnetic field characteristics of tubular magnetic structures so as to permit the use of low cost sensing devices that have fixed switching parameters and/or limited switchpoint ranges.

In accordance with one aspect of this invention, a kit of parts for varying magnetic field characteristics generated from a magnetic assembly for an active speed sensor comprises, a generally tubular magnet that generates a magnetic field; and a plurality of pole pieces insertable in the generally tubular magnet having respective dimensions for varying the magnetic field.

In accordance with another aspect of this invention, an active speed and position sensor comprises, a sense element for sensing a magnetic field; a generally tubular magnet that generates the magnetic field; and a plurality of pole pieces insertable in the generally tubular magnet having respective dimensions for varying the magnetic field.

In accordance with another aspect of this invention, a magnetic assembly apparatus for use in active speed sensors for varying magnetic field characteristics comprising: a generally tubular magnet; and a plurality of pole pieces insertable in the tubular magnet having respective dimensions for varying a magnetic field.

In accordance with another aspect of this invention, a method for varying magnetic field characteristics generated from a magnetic assembly for an active speed sensor, comprises, coupling a plurality of pole pieces inserted into a generally tubular magnet; varying dimensions of the plurality of pole pieces; and generating a varying magnetic field via the plurality of pole pieces.

### BRIEF DESCRIPTION OF DRAWINGS

FIG. 1a is a top section view of a tubular magnet showing unoptimized field region and sensing device.

FIG. 1b is a cross section view of a tubular magnet showing unoptimized field region and sensing device.

FIG. 2a is a top section view of a tubular magnet showing optimized field region, pole piece assembly, and sensing device.

FIG. 2b is a cross section view of a tubular magnet showing optimized field region, pole piece assembly, and sensing device.

FIG. 3a is a perspective view of a square shaped magnet.

FIG. 3b is a perspective view of a rectangular shaped magnet.

FIG. 3c is a perspective view of an ellipsoidal shaped magnet.

FIG. 4 is a perspective view of a sensor with magnet assembly.

### DETAILED DESCRIPTION OF DRAWINGS

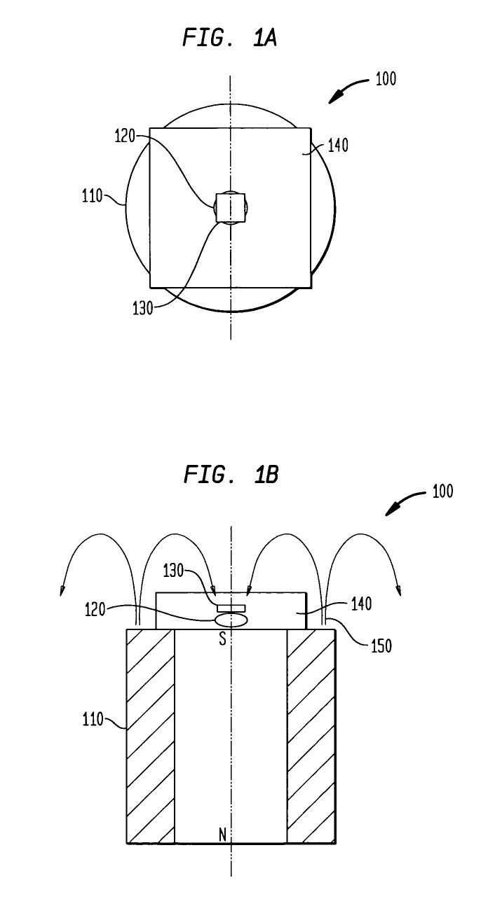

Referring to FIGS. 1a and 1b, the prior art magnetic assembly 100 uses a self-adjusting threshold device with tubular magnet 110. The magnet geometry produces a magnetic “sweet spot” 120 also known as a usable magnetic field. The size, shape, and location of the “sweet spot” 120 is limited in the prior art by variations in magnet geometry. The sensor device manufacturer encapsulates the integrated circuit containing the sensor element 130 within a plastic package 140 in order to protect the integrated circuit. In the prior art, the switchpoints in the sensor device are self adjusting to accommodate the quiescent magnetic levels and signal fluctuations prevailing at the sensor element 130. Use of self-adjusting devices allows correction for large variation in the quiescent magnetic field, but results in an expensive device.

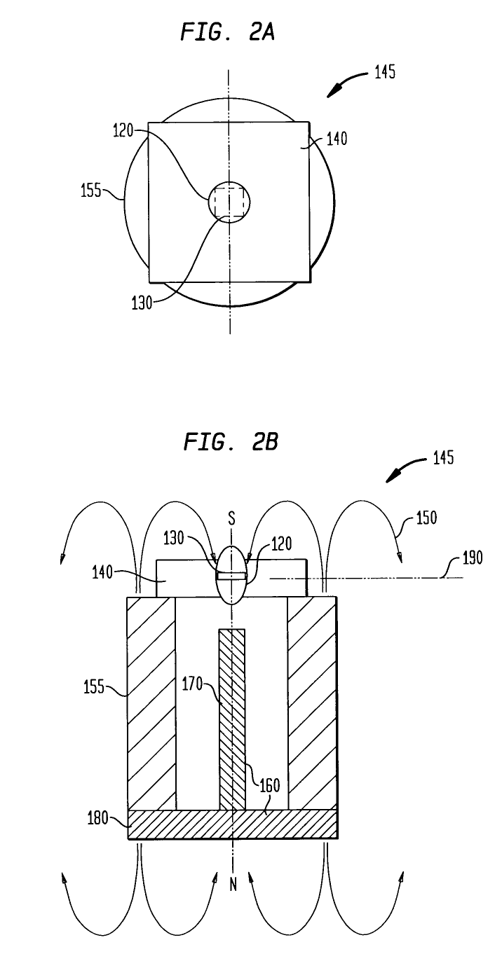

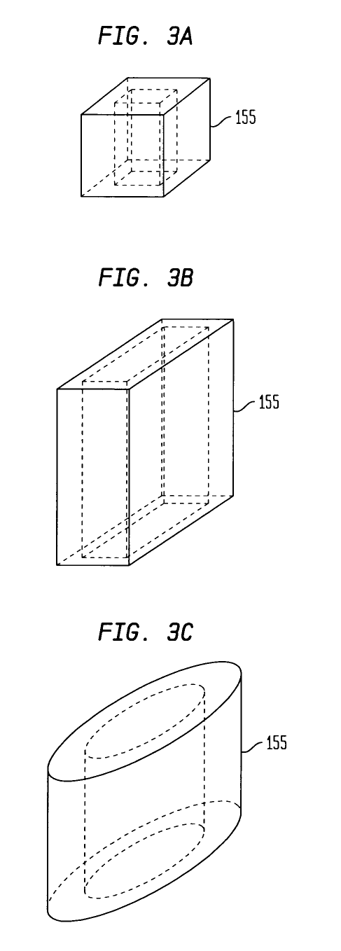

Referring to FIGS. 2a and 2b, present invention uses a magnetic assembly 145 controlling the magnetic field 150 using less expensive devices. The nature of the tubular magnet 155 creates a condition where the magnetic field 150 will not only wrap around the outside of the tubular magnet 155, but will also wrap inward through the hollow core of the tubular magnet 155 as the magnetic flux seeks a return path to the opposite pole. A null magnetic field condition results along the cylindrical axis of the tubular magnet 155. This null region projects outward from the face of the tubular magnet 155. This projecting region is the magnetic “″sweet spot” 120. The “sweet spot” 120 is defined as a magnetic region projecting outward from a magnetic pole of a tubular magnet 155 where the magnetic field levels are low relative to the fields emanating from the magnet poles. The present invention exploits the hollow core of the tubular magnet 155 by introducing a permeable pole piece assembly 160 to exert control of the size, shape, and location of the magnetic “sweet spot” 120 independent of magnet geometry. The shape of the tubular magnet 155 is not limited to a cylinder. Others skilled in the art may choose a shape other than a cylinder for the tubular magnet 155 including square, rectangular, and ellipsoidal shapes as shown in FIGS. 3a-3c.

Pole piece assembly 160 preferably comprises soft, highly permeable magnetic material such as 1008 steel. The pole piece assembly 160 consists of a cylindrical core 170 and a pole plate 180 coupled perpendicularly to each other. The cylindrical core 170 is positioned coaxially in the center of the longitudinally polarized tubular magnet 155 such that the pole plate 180 magnetically couples to one face of the polarized tubular magnet 155. Pole piece assembly 160 conducts the magnetic field 150 through itself. The pole piece assembly 160 allows control over several parameters of the magnetic field 150, including, the magnitude of the magnetic field 150 and the polarity of the magnetic field 150 that exist in the sensing plane 190 of the sensing element 130. The dimensions of the cylindrical core 170, i.e. diameter and length and taper, may be altered to change both the shape of the magnetic field 150 and the quiescent field magnitude at the precise location of the sensing element 130. Similarly, the thickness of the pole plate 180 may be modified to further affect the same field characteristics. Preferably, the pole piece assembly 160 may be manufactured as a single screw machine component to reduce cost. Optimization of the length, diameter, and thickness dimensions of pole piece assembly 160 result in a very low cost method of controlling the magnetic field characteristics so as to permit the use of low cost sensing element 130 that have fixed switching parameters and/or limited switchpoint ranges. Some sensing elements 130, i.e. Allegro 3266, have an OTP switchpoint range of 60-200 gauss. Without the pole piece assembly 160 to draw the magnetic field 150 inward, a preferable tubular NeFeB magnet 155 might produce a quiescent field level 300-500 gauss in the sensing plane 190, which is well above the range that would permit use of most low cost sensing elements 130.

In the prior art, a tubular magnet 110 without the pole piece assembly 160 could not attain the right magnetic field strength in the plane of the sensing element 130. For instance, the magnetic field strength was either too low or too close to the surface of the magnet to be useful. In that embodiment, the “sweet spot” 120 existed in a narrow region so close to the face of the tubular magnet 110 that packaging limitations of sensing element 130 preclude coincident location of the sensing element 130 and the “sweet spot” 120.

The opposing pole of the magnetic field 150 is conducted via the pole piece assembly 160 through the hollow core of the tubular magnet 155, to a location near the sensing element 130. By conducting the opposing pole closer to the sensing plane 190, control over the “sweet spot” 120 may be exercised by altering the geometry of the pole piece assembly 160. This control is realized primarily as a reduction in the absolute field strength present in the sensing plane 190 to levels near zero gauss. It is this reduction in field strength in the sensing plane 190 that permits the use of many low-cost fixed threshold and OTP devices.

The pole piece assembly 160 changes the shape of the magnetic field 150 such that the area of usable field or sensor “sweet spot” 120 is improved in two important ways. First, the presence of the pole piece assembly 160 stabilizes the gradient of field intensity in the plane of the sensing element 130 by dispersing the magnetic field 150 over an area controlled by the geometry of the cylindrical core 170. This is an important characteristic in allowing a greater positioning error for the sense element 130 without sacrificing performance of the sense element 130. Secondly, the magnetic field 150 is projected further out the face of the polarized tubular magnet 155 with a steep field gradient of magnetic field strength. This gradient is determined by controlling the geometry of the pole piece assembly 160. This enables a greater sensing range, and produces a larger magnetic fluctuation when the magnetic assembly 100 is influenced by an application target, resulting in improved switching positional accuracy of the sensing element 130.

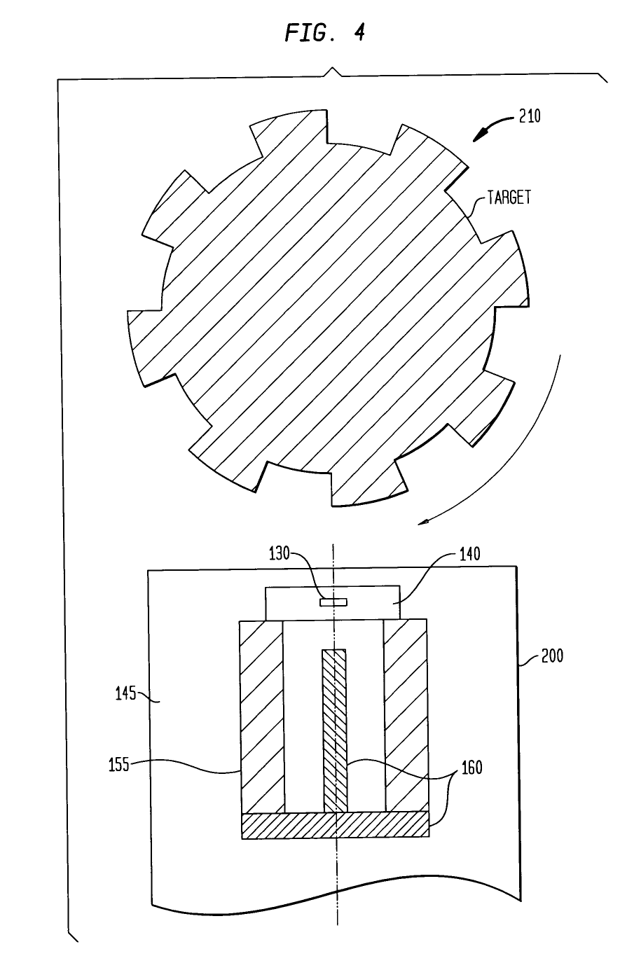

Referring to FIG. 4, during operation, as the magnetic assembly 145 in a sensor body 200 interacts with an application target 210. Perturbations in the magnetic field 150 caused by target irregularities moving past the face of the sensing element 130 comprise the signal on which the sensor acts to produce output switching behavior.

While the present invention has been disclosed with reference to certain embodiments, numerous modifications, alterations, and changes to the described embodiments are possible without departing from the sphere and scope of the present invention. Accordingly, it is intended that the present invention not be limited to the described embodiments and equivalents thereof.

1. A kit of parts for varying magnetic field characteristics generated from a magnetic assembly for an active speed sensor comprising:
a generally tubular magnet that generates a magnetic field; and
a plurality of pole pieces insertable in the generally tubular magnet having respective dimensions for varying the magnetic field.

2. An active speed and position sensor comprising:
a sense element for sensing a magnetic field;
a generally tubular magnet that generates the magnetic field; and
a plurality of pole pieces insertable in the generally tubular magnet having respective dimensions for varying the magnetic field.

3. The apparatus of claim 2, wherein the sense element comprises a Hall Effect or a Magneto-Resistor sensor.

4. The apparatus of claim 2, wherein the generally tubular magnet comprises a shape of a cylinder, a square, a rectangle, or an ellipsoid.

5. The apparatus of claim 2, wherein the plurality of pole pieces comprises a cylindrical core coupled perpendicularly to a pole plate.

6. The apparatus of claim 5, wherein the cylindrical core is positioned coaxially in a center of the tubular magnet.

7. The apparatus of claim 5, wherein the pole plate couples to a pole of the tubular magnet.

8. The apparatus of claim 5, wherein the cylindrical core is cylindrically shaped or taper shaped.

9. The apparatus of claim 5, wherein the pole plate is cylindrically shaped or taper shaped.

10. The apparatus of claim 5, wherein the cylindrical core comprises a soft, highly permeable magnetic material.

11. The apparatus of claim 5, wherein the pole plate comprises a soft, highly permeable magnetic material.

12. The apparatus of claim 2, wherein the generally tubular magnet is polarized.

13. A magnetic assembly apparatus for use in active speed sensors for varying magnetic field characteristics comprising:
a generally tubular magnet; and
a plurality of pole pieces insertable in the tubular magnet having respective dimensions for varying a magnetic field.

14. The apparatus of claim 13, wherein the generally tubular magnet comprises a shape of a cylinder, a square, a rectangle, or an ellipsoid.

15. The apparatus of claim 13, wherein the plurality of pole pieces comprises a cylindrical core coupled perpendicularly to a pole plate.

16. The apparatus of claim 15, wherein the cylindrical core is positioned coaxially in a center of the tubular magnet.

17. The apparatus of claim 15, wherein the pole plate couples to a pole of the generally tubular magnet.

18. The apparatus of claim 15, wherein the cylindrical core is cylindrically shaped or taper shaped.

19. The apparatus of claim 15, wherein the pole plate is cylindrically shaped or taper shaped.

20. The apparatus of claim 15, wherein the cylindrical core comprises a soft, highly permeable magnetic material.

21. The apparatus of claim 15, wherein the pole plate comprises a soft, highly permeable magnetic material.

22. The apparatus of claim 13, wherein the generally tubular magnet is polarized.

23. A method for varying magnetic field characteristics generated from a magnetic assembly for an active speed sensor, comprising:
coupling a plurality of pole pieces inserted into a generally tubular magnet;
varying dimensions of the plurality of pole pieces; and
generating a varying magnetic field via the plurality of pole pieces.

24. The method of claim 23, wherein the generally tubular magnet comprises a shape of a cylinder, a square, a rectangle, or an ellipsoid.

25. The method of claim 23, wherein the plurality of pole pieces comprises a cylindrical core coupled perpendicularly to a pole plate.

26. The method of claim 25, wherein the cylindrical core is positioned coaxially in a center of the tubular magnet.

27. The method of claim 25, wherein the pole plate couples to a pole of the tubular magnet.

28. The method of claim 25, wherein the cylindrical core is cylindrically shaped or taper shaped.

29. The method of claim 25, wherein the pole plate is cylindrically shaped or taper shaped.

30. The method of claim 25, wherein the cylindrical core comprises a soft, highly permeable magnetic material.

31. The method of claim 25, wherein the pole plate comprises a soft, highly permeable magnetic material.

32. The method of claim 23, wherein the generally tubular magnet is polarized.
